(19) United States
(12) Patent Application Publication
(10) Pub. No.: US 2011/0130945 A1
(43) Pub. Date: Jun. 2, 2011

(54) METHOD AND SYSTEM FOR CONTROLLING VEHICLES CARRYING HAZARDOUS MATERIALS

(75) Inventors: Conal P. Deedy, Greensboro, NC (US); Willard S. Yeakel, Greensboro, NC (US)

(73) Assignee: Volvo Group North America, Inc., Greensboro, NC (US)

(21) Appl. No.: 12/448,319

(22) PCT Filed: Dec. 21, 2006
(86) PCT No.: PCT/US06/48889

§ 371 Date: Aug. 19, 2009

(51) Int. Cl. G06F 19/00

(52) U.S. Cl. 701/112

(57) ABSTRACT

A system and method for controlling navigation of a vehicle carrying hazardous materials includes a control module carried on-board the vehicle storing an information matrix containing hazardous material classifications associated with the identity and location of restricted sites. Each site and material pair has associated with it a control zone around it from which the hazardous material is restricted. The control module includes a positioning device that produces a signal indicating the vehicle's current position, which is compared to the coordinates for the control zones. If the vehicle crosses into a control zone, the system generates a warning to the operator. Further penetration causes the system to order a shutdown of the vehicle engine to prevent further movement.

### BACKGROUND AND SUMMARY

The invention relates to systems and methods for controlling navigation of a vehicle. More specifically, the invention is a method and system for controlling a vehicle carrying hazardous materials to avoid selected geographic locations where the hazardous material poses a risk at the geographic location.

Vehicles such as trucks, trains, and boats can carry hazardous material (hazmat) loads that may pose risks to people or structures. Explosive or inflammable materials pose obvious risks. Other materials may pose a risk if they leak or are accidentally or intentionally released from their containers. Further, some hazardous materials can be used to intentionally cause harm to people or property, as, for example, if hijacked or stolen and used as a weapon.

The US Department of Transportation, as well as the United Nations and other governmental bodies, maintains a system for classifying and labeling hazardous materials carried by commercial vehicles, which is set out in 49 CFR Parts 100-185. The US system includes diamond shaped placards that are placed on the vehicle to identify the type or class of hazardous material and information on the hazard posed by that material. The information on the placards may consist of text, a numerical indicator of the hazardous material classification, a symbol, and color. For example, the placard for flammable gas includes a red background with the words “flammable gas” in white letters, a flame symbol, and the classification number “2”. There are nine hazard classes: Explosives (class 1), Gases (class 2), Flammable and combustible liquids (class 3), Flammable solids and dangerous when wet materials (class 4), Oxidizers and organic peroxides (class 5), Toxic material and infectious substances (class 6), Radioactive materials (class 7), Corrosive materials (class 8), and Miscellaneous dangerous goods (class 9). In addition, each class contains subclasses or divisions to more specifically identify hazardous materials. The placard information is used by transportation workers, emergency responders, and regulating authorities to ensure the proper handling and monitoring of hazardous material loads.

The placards also indicate whether a cargo is permitted to move through tunnels, over bridges, or over certain routes.

The placard system relies on the compliance of the vehicle owners and operators and on the available resources of the regulatory and law enforcement authorities. What is needed is a system that combines an on-board vehicle control system and the placard system information to actively control the vehicle from within the vehicle. Such a system could prevent a vehicle transporting hazardous materials from entering a restricted area without the intervention of outside authorities.

The invention provides the vehicle an on-board system that stores information on hazmat classes and subclasses and the coordinates of selected geographical locations, and associates for each combination of a hazmat class and subclass and geographical location a control zone around that geographical location. The control zone defines an area that is restricted to the vehicle carrying a particular hazmat and in which certain actions may be taken by the system according to the invention. Preferably, each geographic location has an associated control zone for each hazmat subclass.

The control zone parameters are determined according to the risk that each hazmat poses to the geographic location. The parameters include the size and boundaries of the control zone and the controls that are activated for a vehicle in the control zone. According to one aspect of the invention, a control module controls the vehicle engine or powerplant responsive to the vehicle entering a control zone, either to slow or stop the vehicle that is in a control zone.

The system includes a device to accept an input of the hazmat identification class or subclass of the material being carried on the vehicle, which is used to determine the appropriate control zones as the vehicle approaches a restricted geographic location.

According to another aspect of the invention, the system includes means for identifying the location of the vehicle and comparing that location to the control zones of the selected geographical locations. Preferably, the means comprises a global positioning system (GPS) receiver functionally connected to a controller of the system. Alternatively, other devices may be employed, for example, a receiver for a land-based positioning system, or an on-board dead-reckoning device.

According to yet another aspect of the invention, the system is adapted to generate a warning to the vehicle operator if the vehicle approaches or enters a control zone restricted for the hazmat class for the vehicle load. The warning may include information to guide the operator to a detour to avoid the control zone.

The invention defines a stop perimeter in the control zone wherein, if the vehicle enters the stop perimeter, the system generates a stop signal to the vehicle controller or engine controller to shut down the vehicle engine, preventing further movement of the vehicle. The shutdown signal may be accompanied by a signal to engage the vehicle's braking system.

According to another aspect of the invention, for a system on a truck, the slow down or shutdown instruction may also trigger a signal to lock the fifth wheel to prevent unhitching the trailer from the tractor.

According to the invention, a control zone for each geographic location and hazmat combination is defined according to the hazard posed by the particular hazardous material class, the sensitivity of the geographic location to that particular hazard, and the available alternative routes (e.g., roads or rail switches) that approach or pass the geographic location.

The control zones may also be defined by an authorization of the driver and/or vehicle to enter a zone for a legitimate purpose (authorized delivery of a hazmat, for example).

The control zones may be dynamically defined by current vehicle conditions or factors. According to one aspect, the speed at which the vehicle is traveling might be monitored and used to change the size of the control zone, where a higher vehicle speed represents an increased risk and an accordingly larger control zone will be defined.

According to another aspect of the invention, the system is adapted to send a message to a location remote of the vehicle when the vehicle enters the control zone. In one embodiment, the system sends a message to the vehicle dispatcher or central station to alert the station that the vehicle has passed any of the warning, slow down and stop perimeters. The central station may be a monitoring station that will forward the message to the appropriate authority for action. According to another embodiment, the system may also send a message directly to regulatory, security, or law enforcement agencies if the vehicle passes any of the perimeters in the control zone, and in particular, the stop or shutdown perimeter.

According to yet another aspect of the invention, the control module includes or is connected to receive map information and is adapted to receive start and destination information from the operator. The system uses the information on the class of transported material and the stored hazmat and selected geographic location information to plot a route for the vehicle that avoids locations restricted for the material being carried.

### BRIEF DESCRIPTION OF THE DRAWINGS

The invention will be better understood by reference to the following Detailed Description read in conjunction with the appended figures, in which,

FIG. 1 is a schematic drawing of a system in accordance with a preferred embodiment of the invention;

FIG. 2 is a schematic drawing of a control zone around a geographic location that may be established by the system according to one embodiment;

FIG. 3 is a schematic of an alternatively configured control zone;

FIG. 4 is a flow diagram of a preferred method according to the invention.

### DETAILED DESCRIPTION OF THE INVENTION

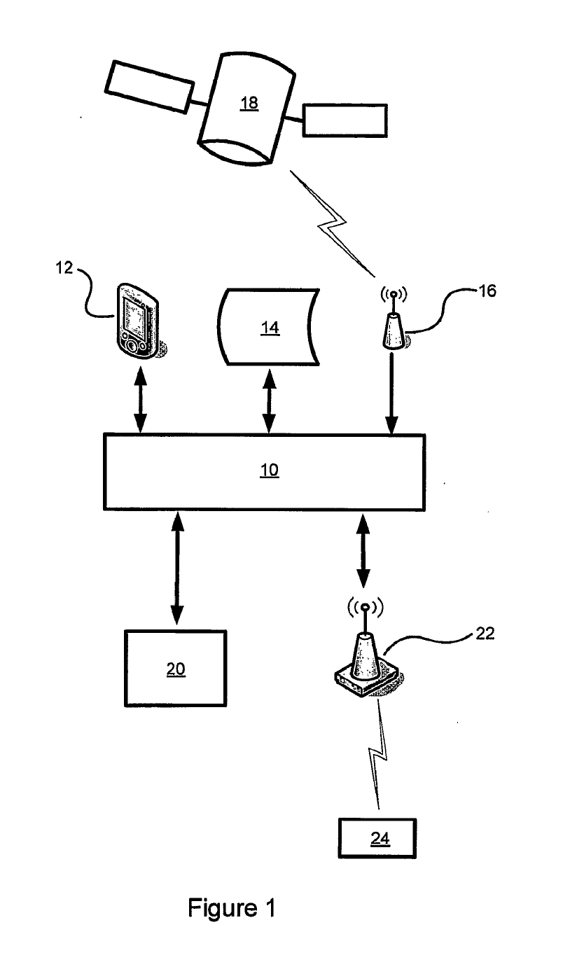

Referring now to FIG. 1, the invention provides a system and method for controlling a vehicle transporting hazardous materials (hazmats) to avoid designated geographic locations or landmarks. The system includes a control module 10 that is installed on-board the vehicle. The vehicle could be a truck (tractor-trailer or other), a train, or a water vessel such as a freighter, a tug or a barge. The description of the invention provided here, although written in terms of a tractor trailer combination as an exemplary embodiment of the invention, applies to any such vehicle as will be understood by those skilled in the art. Differences in the invention related to a particular type of vehicle or aspects specific to a particular type of vehicle are noted.

The control module 10 is connected to or includes a memory device 14 which stores information associating selected geographical locations or landmarks, collectively referred to here as “sites,” with each of the hazmats in the hazardous materials classification system. The information may be stored in any convenient manner, and may, for example, be arranged as a matrix associating each site with each hazardous material class and subclass in the hazardous material classification system. The sites may include any site from which hazardous materials are excluded or restricted, such as may be defined by federal, state or local government authority. These may include individual buildings, such as government buildings, schools, hospitals, or larger sites, such as military installations, airports, or city business districts. The sites may also include bridges, tunnels, historical landmarks, and the like. Each site will be stored with or as its geographic coordinates, i.e., longitude and latitude.

The pairing or association of a site with a hazardous material class or subclass is used by the system to establish a control zone around that site specific to the risk that hazardous material poses to that site. The control zone defines an area around the site from which the system will act to restrict the vehicle, and consequently, the hazardous material. Advantageously, as described below, the invention can be configured to allow for controlled access within a control zone, that is, to allow a vehicle entry to the control zone under specific conditions. The risk a hazardous material poses to a particular site will depend on the nature of the hazardous material and the sensitivity of the site to that material. For example, high explosives and flammable materials pose a risk requiring a larger zone than materials that require close proximity or direct contact to cause harm, such as paints. Also, the quantity of material being carried may be considered in assessing the risk of the material, such as is done in the DOT placard system where certain hazmats have a threshold quantity of 1001 pounds, below which no placard is required.

The sensitivity of the site may depend on the nature or purpose of the site, its structure, the potential that harm to the site could spread or cause harm to another site or the surrounding area, or the symbolic value of the site. For example, the US Capitol, the White House, and state capital buildings are highly sensitive because of the harm to people and the disruption of government that might occur, and also as symbols of government. The nature of the site would also include whether a particular hazardous material has no legitimate use at the site. The control zones around these types of sites would be relative large and would likely be restricted to all hazardous materials. For example, the control zone around a sensitive site may be a two-mile radius for high hazardous materials, like explosives or flammable materials. On the other hand, the control zone for class 9 goods like lithium batteries or asbestos may be a quarter mile for this sensitive site.

Other sites, such as tunnels, restrict nearly all hazardous materials because the potential of harm to people using the tunnel and to emergency responders who may have to enter, and the risk of shutdown of the tunnel. Bridges, on the other hand, may be restricted to some hazmats, typically explosives, and not others.

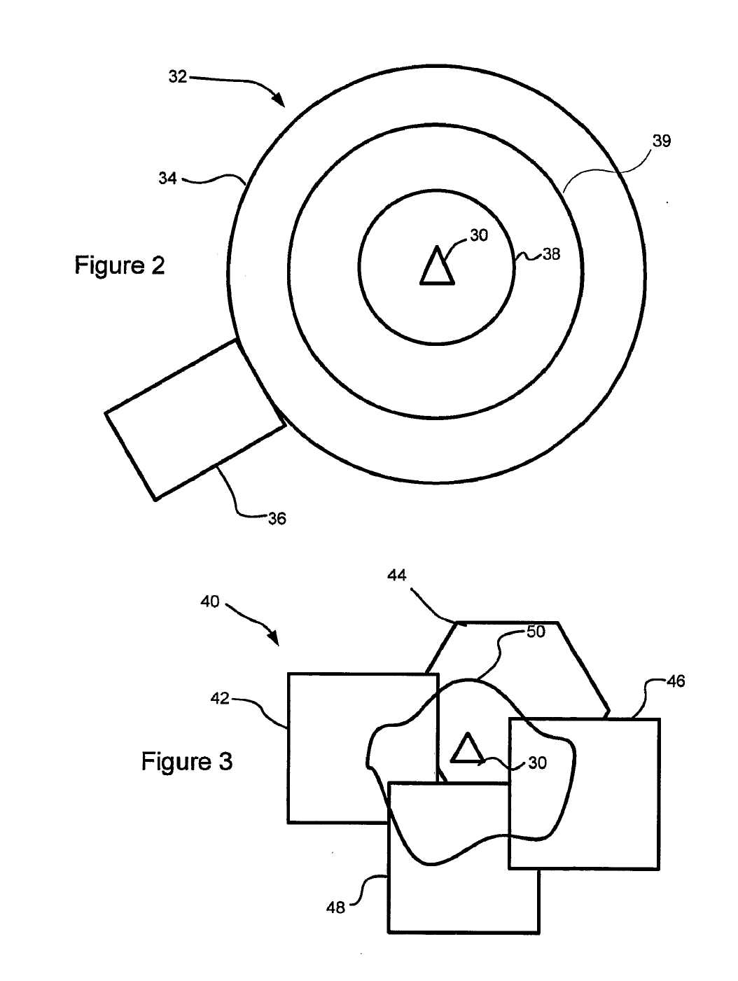

Another factor in determining the size of a control zone is the availability of alternative routes for avoiding the restricted site and the proximity of the alternative routes to the restricted site. Turning now to FIG. 2, a restricted site 30 is indicated schematically as a triangle surrounded by a control zone 32 having an outer perimeter 34 and a rectangular area 36. The control zone 32 as defined is understood to be superimposed over a map (not illustrated). The rectangular area 36 indicates a portion of the control zone 32 around a route that enters the control zone without opportunity to turn away, for example, a stretch of controlled access road such as interstate highway that has no exit before the control zone. This may also represent rail track that has no switch areas approaching a restricted site, or a stretch of a waterway approaching a bridge or port, for example.

Returning to FIG. 1, the control module 10 is connected to receive and store an input including at least the hazmat class or classes (including subclasses) for the load being carried by the vehicle. As illustrated, the input may be from an interface device 12. This may be a keypad or touch screen or similar device installed, for example, on the dashboard of a truck or an operator's console of the vehicle. Alternatively, the load data input may be provided from a source external to the vehicle, for example, wirelessly from a dispatch station. The input may also include information related to the quantity of the hazardous material on board the vehicle. Optionally, the input may also include the vehicle's starting point and destination. Further, the input may also include the identification of the driver or drivers authorized and assigned to operate the vehicle with the particular load.

The control module 10 is also connected to receive vehicle location information from an onboard device. In the illustrated embodiment, the device is a global positioning system (GPS) receiver 16 that receives signals from a satellite system 18. Alternatively, the receiver could receive signals from a land-based positioning system. Yet another alternative includes an onboard dead reckoning system that calculates the vehicle's position as it moves from direction and distance monitored information. Alternatively, such an on-board dead reckoning system can serve as a back up in the event of a failure of the external system or tampering with the GPS receiver or antenna.

The control module 10 is also functionally connected to the vehicle's electronic control unit (ECU) 20 that controls the vehicle engine or power plantand other vehicle functions. The control module 10 sends signals to the ECU 20 to control the vehicle in relation to a control zone, as will be explained below.

The control module 10 is also connected to a transceiver 22 to send messages to a location 24 remote of the vehicle, which may be one or more of a vehicle dispatch station, a vehicle monitoring or tracking station, and a regulatory authority or enforcement authority when an event involving a control zone occurs.

Turning again to FIG. 2, a control zone 32 may be defined and stored in the memory 14 as coordinate points having a defined distance from the site 30. The control zone may be defined conveniently having a circular perimeter 34, as shown in FIG. 2. Alternatively, referring to FIG. 3, a control zone 40 may have boundaries having another shape, or may be a composite of several areas which may or may not have a similar shape. The exact shape of the perimeter, as mentioned, will depend on the characteristics of the site and its environs, available access and detour routes, the presence of natural or artificial barriers (e.g., rivers, geologic features) or other considerations as may be encountered.

According to one embodiment, a control zone 32 includes an outer perimeter 34 and an inner perimeter 38. The outer perimeter 34 defines a warning zone, within which the vehicle operator is warned that the vehicle has crossed into a control zone 32. The warning zone serves as an approach area to the protected inner perimeter, and will typically be sufficiently large to allow for corrective action by the driver, among other actions. The warning directs the operator to change course to take the vehicle out of the control zone 32 before crossing the inner perimeter. The inner perimeter 38 defines a shutdown zone. If the vehicle crosses the shutdown perimeter, the control module 10 will act to shutdown the vehicle to prevent further movement.

In FIG. 3, the warning perimeter is defined by the composite of smaller zones 42, 44, 46 and 48 which may be a more effective way to determine the outer control zone because of local geographic, road, or other features. The shutdown zone is defined by the inner-positioned FIG. 50.

Alternatively, returning to FIG. 2, the control zone 32 may include an additional perimeter 39 between the outer perimeter and inner perimeter within which the control module 10 will act to slow the vehicle to a predetermined speed. The slow down perimeter may alternatively be co-extensive with the outer perimeter.

According to another aspect of the invention applicable to a tractor-trailer, the controller 10 may send a signal to cause the tractor fifth wheel to lock the hitch to prevent the tractor and trailer from being separated. Because the system of the invention is carried on the tractor, control of the trailer depends on being hitched to the controlled tractor. This signal may be given when the tractor-trailer begins the trip, which provides the greatest security. Alternatively, the lock signal may be given when the vehicle enters a control zone. The fifth wheel lock device may also be activated if the system is tampered with, for example, if the GPS receiver or antenna is disabled. A system for locking a fifth wheel is disclosed in US Patent Application Publication No. 2004/0145150, which is owned in common with the present invention, the contents of which are incorporated herein by reference.

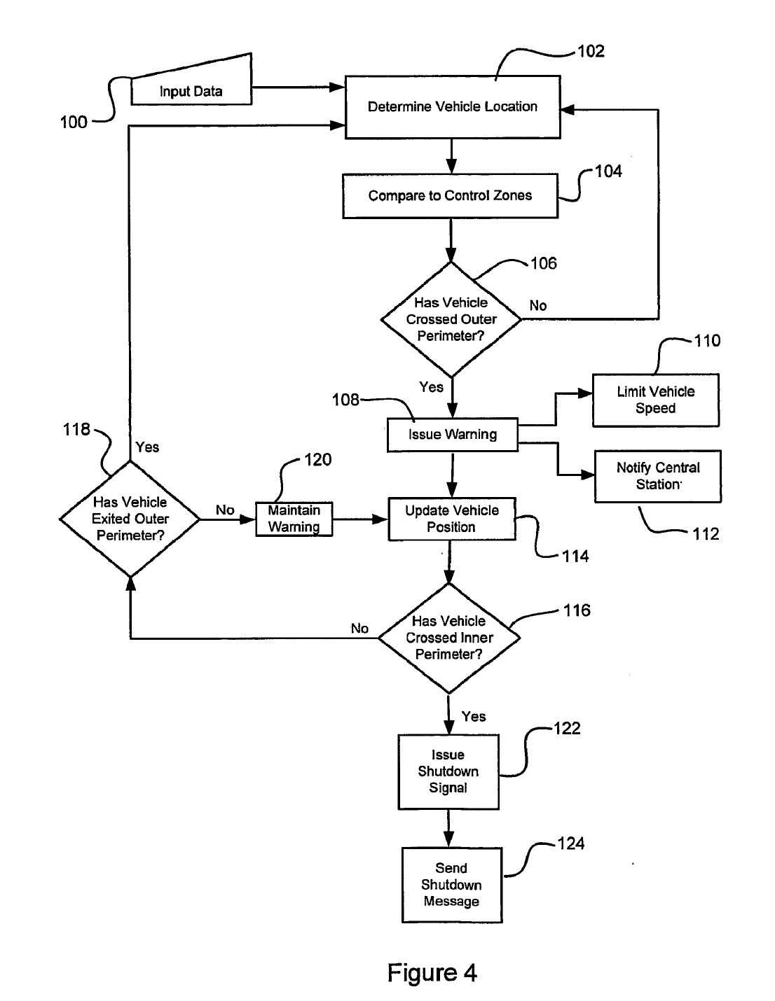

The operation of the system and method according to one embodiment the invention will be explained in conjunction with FIG. 1 and FIG. 4. When the vehicle is loaded in preparation for a trip, the driver or operator or another person, locally or remotely, will enter start data into the system, at step 100 through the interface 12. The start data will include the hazmat class or subclass for the material or materials being carried. The data may also include a quantity of the hazmat material, as this may be important to the definition of control zone for that material. In addition, the data may include the starting location and destination of the vehicle. The data may optionally include driver identification and authorization, which may be biometric (e.g., a fingerprint input) or another device.

The control module 10 may optionally provide trip navigation assistance to the operator based on the starting point and destination, calculated to avoid sites for which the cargo is restricted. This information may be presented to the driver in a manner similar to conventional navigation systems.

Once the vehicle is in transit, the system will continually determine the vehicle location (step 102), using the onboard GPS device 16 or another means providing a position signal to the control module 10. The control module 10 compares the current vehicle location to the coordinates of the sites and their associated control zones stored in the memory 14 at step 104. The system 10 will then determine whether the vehicle has crossed an outer perimeter of any of the control zones. if no, the control module 10 returns to monitoring the vehicle position.

If the vehicle has crossed an outer perimeter, the control module 10 will generate a signal warning the operator of the vehicle's entry into a control zone at step 108. The warning message may be sent through the interface 12 or another vehicle communication device. The message will instruct the operator to take certain actions. According to one aspect, the instructions will be to change course to leave the control zone, and this instruction may provide navigation information on alternative routes.

The instruction may be to provide identification so the system can verify that the. authorized driver is operating the vehicle. A failure to properly identify the driver will trigger the system to shutdown the vehicle and alert a tracking station and/or responders.

Optionally, as indicated by step 110, the control module 10 may send a signal to the vehicle ECU 20 to limit vehicle speed to a predetermined level in the control zone. If the particular control zone includes a slow down perimeter different from the warning perimeter, as illustrated in FIG. 2, the control module 10 may refrain from sending the slow down instruction until the vehicle crosses the slow down perimeter.

The control module 10 may optionally send a message to one or more external, remote locations to notify of the vehicle crossing the outer perimeter in step 112. The message may be transmitted by the transceiver 22. Such a message may be of interest to the vehicle's owner at a dispatch as an early indication of a problem at the vehicle or some difficulty being experienced by the driver, for example, getting lost or being detoured because of an accident or road construction. The signal may also be sent to a tracking station, for example, a contract service that monitors moving vehicles for the owner, and provides assistance and information to the drivers. The tracking station would be equipped to contact the operator to determine the reason for the incursion into the control zone, and offer live assistance.

In the case of a train or boat, the slowdown instruction will cause the power plant to operate at reduced power while still under control. For a boat, for example, the reduced power will be sufficient to allow the operator to maintain control of the boat in the water currents.

The system will then update the vehicle location, in step 114. The control module 10 will determine in step 116 by the comparisons with the stored information whether the vehicle has crossed the inner perimeter of the control zone 32. If the vehicle has not crossed the inner perimeter, the control module will determine whether the vehicle is still within the outer perimeter in step 118. If the vehicle has left the outer perimeter, the system reverts to vehicle location monitoring, and the warning and speed limits are canceled. If the vehicle is still in the outer perimeter, the warning is maintained, in step 120, and control is returned to step 114, where the vehicle location is updated.

If the vehicle has crossed the inner perimeter, the control module 10 issues a signal to the vehicle ECU 20 or equivalent device at step 122 to shutdown the vehicle engine or power plant, in the case of a truck or train, to halt further movement This signal may be implemented by the ECU 20 as a fuel cut off signal or other appropriate signal. An example of an on-board system for shutting down a vehicle engine is disclosed in US Patent Application Publication No. 2005/0187693, which is owned in common with the present invention and the contents of which are herein incorporated by reference. The shutdown signal may include a command to engage the vehicle brakes. With the signal to shutdown, the control module 10 will send a message to a remote location that the vehicle has been shutdown. The message may be transmitted by the transceiver to one or more of the vehicle tracking station, a regulatory agency, a law enforcement agency, and a security agency. These entities may then take appropriate action to investigate the shutdown and order appropriate response.

In the case of a barge or other water vessel, the shutdown order may be in the form of an order to hold position, by which the vessel's navigation system and engine will operate to maintain the current position, but not permit further movement. An example of such a system is disclosed in U.S. Pat. No. 6,678,589 to Robertson et al., the contents of which are incorporated herein by reference.

In the event the vehicle has a legitimate purpose in carrying a hazardous material to the restricted site, the system may include a means to override at least the shutdown signal. For example, a vehicle may be delivering hazardous material to a laboratory or hospital. When the vehicle enters the control zone, the system will check the destination stored in memory with the restricted site location, and if they match, will send a signal to the tracking station and/or the restricted site to request permission for the vehicle to enter. The tracking station, if used, will verify the vehicle and/or driver identity, cargo and scheduled destination, and will send a message to the control module allowing it to cancel the shutdown signal. Alternatively, the control unit can send a request to the destination directly, which will have information allowing it to verify the delivery and return a code to the control module allowing it to override the shutdown message.

Alternatively, the system and method may include the step of monitoring the GPS receiver for tampering or disabling. In step 102, if the control module 10 cannot determine the vehicle location because there is no signal from the GPS device, the system would go to step 122 and issue a shutdown, followed by the shutdown message to the external, remote location.

The invention has been explained in terms of preferred components and steps, however, those skilled in the art will understand that substitutions and variations may be made or incorporated without departing from the scope of the invention as defined by the appended claims.

1. A method of directing a vehicle carrying hazardous materials, comprising the steps of:
storing onboard the vehicle information defining a control zone for at least one selected geographic location and at least one hazardous material, the control zone defining an outer perimeter and an inner perimeter;
determining onboard the vehicle a location of the vehicle carrying a hazardous material;
comparing the vehicle location to the control zone for the at least one selected geographic location;
producing a signal based on the comparison, the signal being a warning given to a vehicle operator if the vehicle is inside the warning perimeter and being a shutdown instruction to a vehicle engine controller if the vehicle is inside the shutdown perimeter.

2. The method of claim 1, wherein the control zone defines a slowdown perimeter, and wherein the method comprises producing an instruction to the vehicle engine controller to slow the engine below a predetermined limit if the vehicle is inside the slowdown perimeter.

3. The method of claim 2, wherein the slowdown perimeter is coextensive with the warning perimeter.

4. The method of claim 1, further comprising the step of accepting an input relating to the hazardous material classification for a hazardous material carried by the vehicle.

5. The method of claim 4, wherein the input includes a quantity of the hazardous material.

6. The method of claim 1, further comprising the step of defining a plurality of control zones for the at least one geographic location, each control zone related to a hazardous material classification and a risk posed by such a hazardous material to that geographic location.

7. The method of claim 6, wherein the risk posed by the hazardous material includes information on the quantity of the hazardous material.

8. The method of claim 6, wherein the information stored onboard comprises a matrix associating the at least one geographic location with said plurality of control zones.

9. The method of claim 8, wherein the matrix includes a plurality of geographic locations.

10. The method of claim 1, wherein the step of providing a warning to the vehicle operator includes providing information for detouring from the control zone.

11. The method of claim 1, wherein the step of determining a location of a vehicle comprises receiving a signal from a global positioning system.

12. The method of claim 1, wherein the step of determining a location of a vehicle comprises receiving a signal from a land-based station.

13. The method of claim 1, wherein the step of determining a location of a vehicle comprises calculating the location by dead reckoning.

14. The method of claim 1, further comprising sending a signal to a location remote of the vehicle indicating that the vehicle has entered a control zone.

15. The method of claim 1, further comprising determining that the vehicle is in a controlled operation zone, and producing a signal to an on-board vehicle controller imposing conditions on operation in the controlled operation zone.

16. A system for directing a vehicle carrying a hazardous material to avoid selected geographic locations, the system carried on-board the vehicle and comprising:
a memory storing information defining at least one control zone for at least one hazardous material for at least one geographic location, the at least one control zone including an outer warning perimeter and an inner shutdown perimeter;
a controller operationally connected to the memory to retrieve control zone information and being operationally connected to a vehicle engine control device;
means for determining a location of a vehicle transporting a hazardous material and producing a signal responsive thereto to the controller;
wherein, the controller is adapted to receive the vehicle location information and compare it to the control zone information, and responsive to the comparison, provide a signal to at least one of a vehicle operator and the vehicle engine control device, and
wherein, if the vehicle is in the outer warning perimeter said signal is a warning to the vehicle operator to avoid the control zone and if the vehicle is in the inner shutdown perimeter said signal is a shutdown signal to the vehicle propulsion system.

17. The system as claimed in claim 16, wherein the memory stores a matrix relating a plurality of control zones for the at least one geographic location, each control zone related to a hazardous material classification and a risk posed by such a hazardous material to that geographic location.

18. The system as claimed in claim 17, wherein the risk posed by a hazardous material includes information on a quantity of the hazardous material.

19. (canceled)

20. The system as claimed in claim 16, wherein the control zone further defines a perimeter between the outer perimeter and the inner perimeter to trigger a signal to slow the vehicle propulsion system below a predetermined limit.

21. The system as claimed in claim 16, wherein the means for determining a location of the vehicle comprises a GPS receiver.

22. The system as claimed in claim 16, wherein the memory contains a matrix of selected geographic locations and selected hazardous material classifications, wherein each pairing of geographic location and hazardous material classification is associated with a defined control zone.

23. The system as claimed in claim 16, further comprising a transmitter to transmit information relating to a vehicle location relative to a control zone to a location remote of the vehicle.

24. The system as claimed in claim 16, further comprising means for accepting an input of data on the hazardous material classification of the hazardous material carried by the vehicle.

25. The system as claimed in claim 24, further comprising means for accepting an input of a quantity of the hazardous material carried by the vehicle.
